(19) United States
(12) Patent Application Publication
(10) Pub. No.: US 2018/0009170 A1
(43) Pub. Date: Jan. 11, 2018

(54) PRINT DEAD ZONE IDENTIFICATION

(71) Applicant: HEWLETT-PACKARD DEVELOPMENT COMPANY, L.P., Houston, TX (US)

(72) Inventors: Sebastia Cortes, Barcelona (ES); Xavier Vilajosana, Sant Cugat del Valles (ES); Jun Zeng, Sunnyvale, CA (US)

(73) Assignee: HEWLETT-PACKARD DEVELOPMENT COMPANY, L.P., Houston, TX (US)

(21) Appl. No.: 15/539,321

(22) PCT Filed: Jan. 28, 2015
(86) PCT No.: PCT/US2015/013225

§ 371 Date: Jun. 23, 2017

(51) Int. Cl. B29C 64/393; B22F 3/105; B28B 1/00

(52) U.S. Cl. CPC B29C 64/393; B33Y 30/00; B33Y 50/02; B22F 3/1055; B33Y 10/00; B22F 2003/1057; B28B 1/001; B29C 64/153

(57) ABSTRACT

A sensor may be to detect a property indicative of a print dead zone caused by a defect of build material to be used for generating the three-dimensional object or a malfunction of a heater that is to heat the build material, a build material distributor that is to provide the material, or a carriage. A processor may be to receive, from the sensor, dead zone data relating to the print dead zone, and to prevent the malfunction of the heater, the build material distributor, or the carriage, or to modify data representing the three-dimensional object to cause the three-dimensional object to be shifted such that three-dimensional object is to be printed outside the print dead zone.

### BACKGROUND

Additive manufacturing systems that generate three-dimensional objects on a layer-by-layer basis have been proposed as a potentially convenient way to produce three-dimensional objects. The quality of objects produced by such systems may vary widely depending on the type of additive manufacturing technology used.

### BRIEF DESCRIPTION

Some examples are described with respect to the following figures:

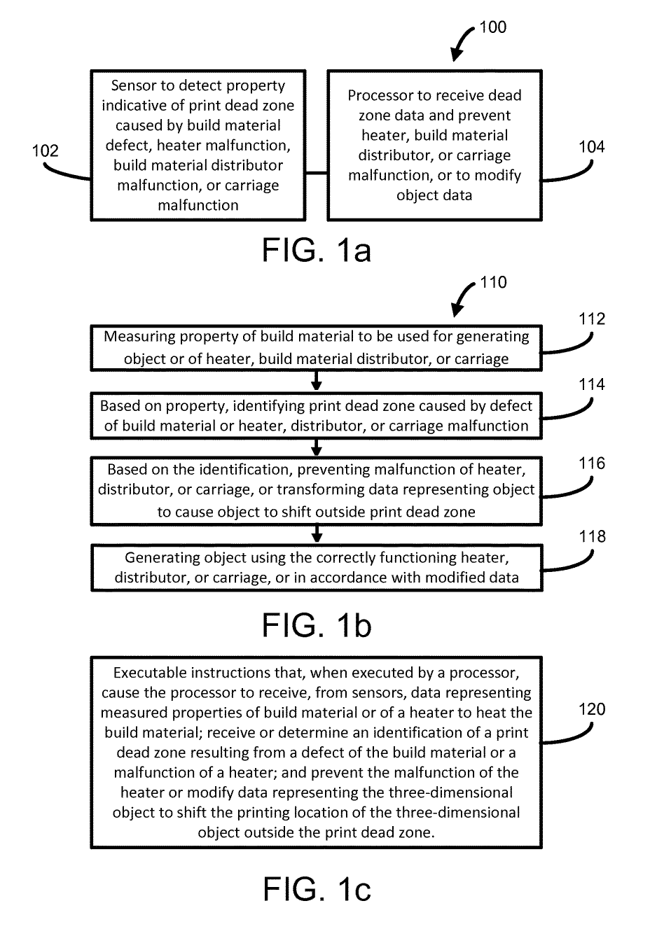

FIG. 1a illustrates a system according to some examples;

FIG. 1b is a flow diagram illustrating a method according to some examples;

FIG. 1c is a block diagram illustrating a non-transitory computer readable storage medium according to some examples;

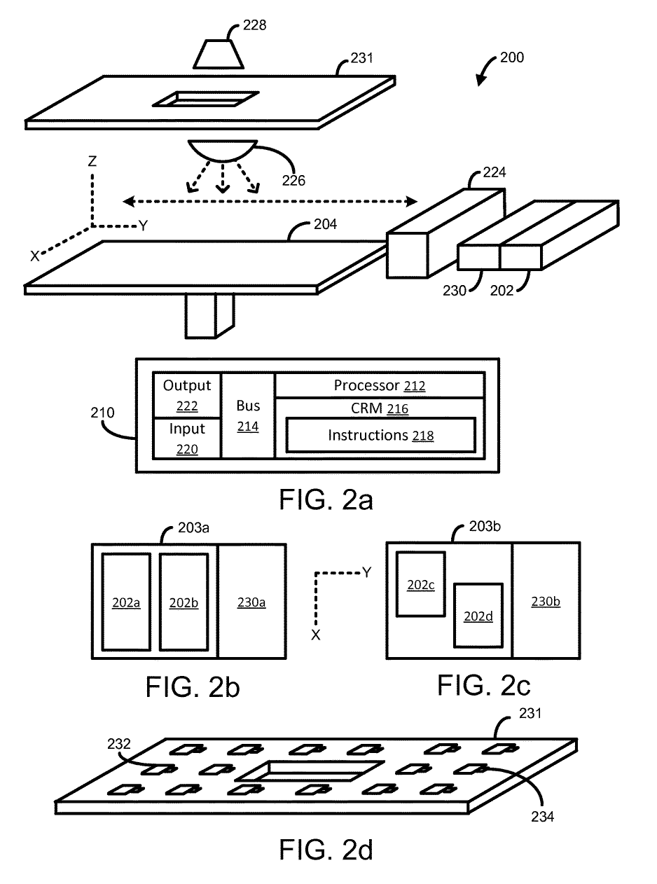

FIG. 2a is a simplified isometric illustration of an additive manufacturing system according to some examples;

FIGS. 2b-c are simplified schematic top views of agent distributors and imaging devices mounted on moveable carriages according to some examples;

FIG. 2d is a simplified isometric illustration of a heater for an additive manufacturing system according to some examples;

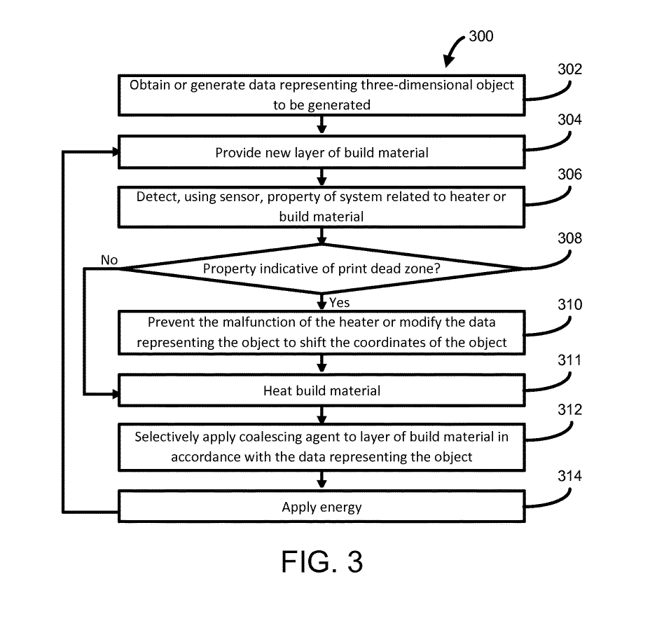

FIG. 3 is a flow diagram illustrating a method of generating a three-dimensional object according to some examples;

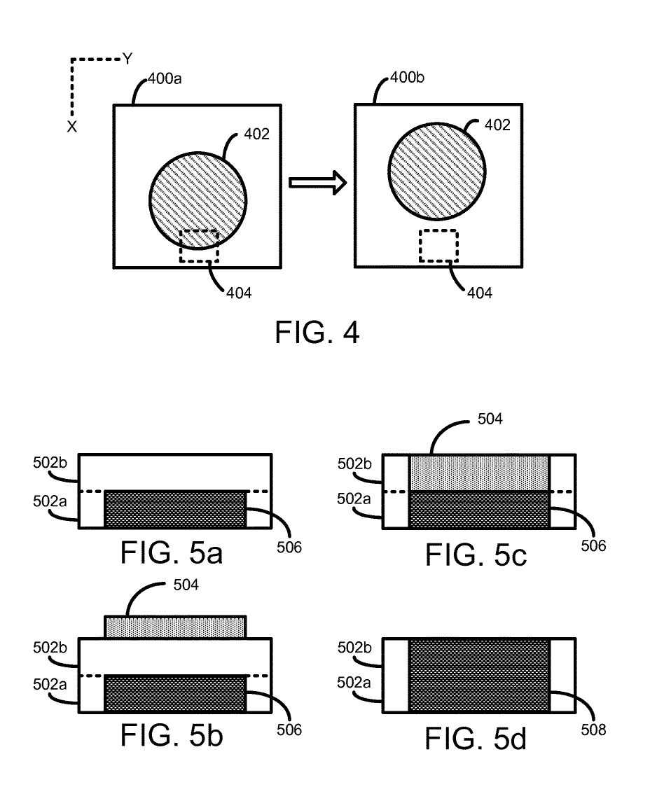

FIG. 4 illustrates data representing a three-dimensional object modified based on dead zone data; and

FIGS. 5a-d show a series of cross-sectional side views of layers of build material according to some examples.

### DETAILED DESCRIPTION

The following terminology is understood to mean the following when recited by the specification or the claims. The singular forms “a,” “an,” and “the” mean “one or more.” The terms “including” and “having” are intended to have the same inclusive meaning as the term “comprising.”

Some additive manufacturing systems generate three-dimensional objects through the solidification of portions of successive layers of build material, such as a powdered, liquid, or fluidic build material. The properties of generated objects may be dependent on the type of build material and the type of solidification mechanism used. In some examples, solidification may be achieved using a liquid binder agent to chemically solidify build material. In other examples, solidification may be achieved by temporary application of energy to the build material. This may, for example, involve use of a coalescing agent, which is a material that, when a suitable amount of energy is applied to a combination of build material and coalescing agent, may cause the build material to coalesce and solidify. In some examples, a multiple agent additive manufacturing system may be used such as that described in PCT Application No. PCT/EP2014/050841 filed on Jan. 16, 2014, entitled “GENERATING A THREE-DIMENSIONAL OBJECT”, the entire contents of which are hereby incorporated herein by reference. For example, in addition to selectively delivering coalescing agent to layers build material, coalescence modifier agent may also be selectively delivered to layers of build material. A coalescence modifier agent may serve to modify the degree of coalescence of a portion of build material on which the coalescence modifier agent has been delivered or has penetrated. In yet other examples, other methods of solidification may be used, for example selective laser sintering (SLS), light polymerization, among others. The examples described herein may be used with any of the above additive manufacturing systems and suitable adaptations thereof.

In some examples, an aspect of the additive manufacturing system such as a heater for heating build material, build material distributor for providing build material, or carriage may malfunction, or build material may have defects such as abnormal accumulation, deformations, holes, obstacles in the print bed, broken or incorrectly positioned parts, or any other defects that may render a particular area of the build material at risk for producing defective parts. This may result in dead zones of build material corresponding to the malfunction of the heater, carriage, or build material distributor, or the defect of the build material. Build material in the dead zones may become more or less solidified than intended, or more generally the generated objects may not be faithful reproductions of three-dimensional object model used to generate the object. Accordingly, the present disclosure provides, in some examples, for preventing generating objects in print dead zones in response to detection of print dead zones by sensors.

FIG. 1a is a block diagram illustrating a system 100 according to some examples. The system 100 may include a sensor 102 to detect a property indicative of a print dead zone caused by a defect of build material to be used for generating the three-dimensional object or a malfunction of a heater that is to heat the build material, a build material distributor that is to provide the build material, or a carriage. The system may include a processor 102 to receive, from the sensor, dead zone data relating to the print dead zone, and to prevent the malfunction of the heater, build material distributor, or carriage, or to modify data representing the three-dimensional object to cause the three-dimensional object to be shifted such that three-dimensional object is to be printed outside the print dead zone.

FIG. 1b is a flow diagram illustrating a method 110 according to some examples. At 112, a property may be measured by a sensor. The property may be of build material to be used for generating a three-dimensional object, or of a heater to be used to heat the build material, a build material distributor that is to provide the build material, or a carriage. At 114, based on the measured property, a print dead zone caused by a defect of the build material or a malfunction of the heater, build material distributor, or carriage may be identified. At 116, based on the identification, the malfunction of the heater, build material distributor, or carriage may be prevented, or data representing the three-dimensional object may be transformed to cause the three-dimensional object to be shifted such that three-dimensional object is to be printed in an area of the build material outside the print dead zone. At 118, the three dimensional object may be generated using the correctly functioning heater, build material distributor, or carriage, or in accordance with the modified data.

FIG. 1c is a block diagram illustrating a non-transitory computer readable storage medium 120 according to some examples. The non-transitory computer readable medium 120 may include executable instructions that, when executed by a processor, may cause the processor to receive, from sensors, data representing measured properties of build material to be used for generating the three-dimensional object or of a heater to be used to heat the build material. The non-transitory computer readable medium 120 may include executable instructions that, when executed by a processor, may cause the processor to receive or determine an identification of a print dead zone resulting from a defect of the build material or a malfunction of a heater, the identification based on the measured properties. The non-transitory computer readable medium 120 may include executable instructions that, when executed by a processor, may cause the processor to prevent the malfunction of the heater or modify data representing the three-dimensional object to shift the printing location of the three-dimensional object outside the print dead zone.

FIG. 2a is a simplified isometric illustration of an additive manufacturing system 200 according to some examples. The system 200 may be operated, as described further below with reference to the flow diagram of FIG. 3 to generate a three-dimensional object.

In some examples the build material may be a powder-based build material. As used herein the term powder-based materials is intended to encompass both dry and wet powder-based materials, particulate materials, granular, and fluidic materials. In some examples, the build material may include a mixture of air and solid polymer particles, for example at a ratio of about 40% air and about 60% solid polymer particles. One suitable material may be Nylon 12, which is available, for example, from Sigma-Aldrich Co. LLC. Another suitable Nylon 12 material may be PA 2200 which is available from Electro Optical Systems EOS GmbH. Other examples of suitable build materials may include, for example, powdered metal materials, powdered composite materials, powdered ceramic materials, powdered glass materials, powdered resin material, powdered polymer materials, and the like, and combinations thereof. It should be understood, however, that the examples described herein are not limited to powder-based materials or to any of the materials listed above. In other examples the build material may be in the form of a paste, liquid or a gel. According to one example a suitable build material may be a powdered semi-crystalline thermoplastic material.

The additive manufacturing system 200 may include a system controller 210. Any of the operations and methods disclosed herein may be implemented and controlled in the additive manufacturing system 200 and/or controller 210.

The controller 210 may include a processor 212 for executing instructions that may implement the methods described herein. The processor 212 may, for example, be a microprocessor, a microcontroller, a programmable gate array, an application specific integrated circuit (ASIC), a computer processor, or the like. The processor 212 may, for example, include multiple cores on a chip, multiple cores across multiple chips, multiple cores across multiple devices, or combinations thereof. In some examples, the processor 212 may include at least one integrated circuit (IC), other control logic, other electronic circuits, or combinations thereof.

The controller 210 may support direct user interaction. For example, the additive manufacturing system 200 may include user input devices 220 coupled to the processor 212, such as a keyboard, touchpad, buttons, keypad, dials, mouse, track-ball, card reader, or other input devices. Additionally, the additive manufacturing system 200 may include output devices 222 coupled to the processor 212, such as a liquid crystal display (LCD), video monitor, touch screen display, a light-emitting diode (LED), or other output devices. The output devices 222 may be responsive to instructions to display textual information or graphical data.

The processor 212 may be in communication with a computer-readable storage medium 216 via a communication bus 214. The computer-readable storage medium 216 may include a single medium or multiple media. For example, the computer readable storage medium 216 may include one or both of a memory of the ASIC, and a separate memory in the controller 210. The computer readable storage medium 216 may be any electronic, magnetic, optical, or other physical storage device. For example, the computer-readable storage medium 216 may be, for example, random access memory (RAM), static memory, read only memory, an electrically erasable programmable read-only memory (EEPROM), a hard drive, an optical drive, a storage drive, a CD, a DVD, and the like. The computer-readable storage medium 216 may be non-transitory. The computer-readable storage medium 216 may store, encode, or carry computer executable instructions 218 that, when executed by the processor 212, may cause the processor 212 to perform any of the methods or operations disclosed herein according to various examples.

The system 200 may include a coalescing agent distributor 202 to selectively deliver coalescing agent to successive layers of build material provided on a support member 204. According to one non-limiting example, a suitable coalescing agent may be an ink-type formulation comprising carbon black, such as, for example, the ink formulation commercially known as CM997A available from Hewlett-Packard Company. In one example such an ink may additionally comprise an infra-red light absorber. In one example such an ink may additionally comprise a near infra-red light absorber. In one example such an ink may additionally comprise a visible light absorber. In one example such an ink may additionally comprise a UV light absorber. Examples of inks comprising visible light absorbers are dye based colored ink and pigment based colored ink, such as inks commercially known as CM993A and CE042A available from Hewlett-Packard Company.

The controller 210 controls the selective delivery of coalescing agent to a layer of provided build material in accordance with agent delivery control data 208 of the instructions 218.

The agent distributor 202 may be a printhead, such as a thermal inkjet printhead or a piezo inkjet printhead. The printhead may have arrays of nozzles. In one example, printheads such as those commonly used in commercially available inkjet printers may be used. In other examples, the agents may be delivered through spray nozzles rather than through printheads. Other delivery mechanisms may be used as well. The agent distributor 202 may be used to selectively deliver, e.g. deposit, coalescing agent when in the form of suitable fluids such as a liquid.

The coalescing agent distributor 202 may include a supply of coalescing agent or may be connectable to a separate supply of coalescing agent.

The system 200 may include a sensor 230, for example a digital camera. The imaging device 230 may be in the form of a scan bar coupled to a movable carriage, examples of which will be described in FIGS. 2b and 2c. The sensor 230 may capture images of the build material by sweeping or scanning over the entire area of the build material. The images may, in some examples, be captured in the visible light range. The images may, for example, be stored in a suitable bitmap format, for example having a resolution of 600 dots per inch. In some examples, the resolution may be greater than the resolution of contone slice data, halftone slice data, and/or mask slice data that may be used for depositing agents. The imaging device 230 may output the images to the controller 210.

FIG. 2b is a simplified schematic top view of agent distributors 202a-b and an imaging device 230a mounted on a moveable carriage 203a according to some examples, and FIG. 2c is a simplified schematic top view of agent distributors 202c-d and the imaging device 230b mounted on a moveable carriage 203b according to some examples. Each of these configurations may be used in the system 200. The agent distributors 202a-d may each have similar features as the agent distributer 202 described earlier. Additionally, the imaging devices 230a-b may each have similar features as the imaging device 230 described earlier.

In FIG. 2b, each of the agent distributors 202a-b has a length that enables it to span the whole width of the support member 204 in a so-called page-wide array configuration. In some examples, each agent distributor 202a-b may be a single printhead having an array of nozzles having a length to enable it to span the width of the support member 204 along the illustrated x-axis, as shown in FIG. 2b. In other examples, a suitable arrangement of multiple printheads may be placed in-line to achieve a page-wide array configuration. Thus, using the carriage 203a, the agent distributors 202a-b and the imaging system 230a may be movable bi-directionally across the length of the support 204 along the illustrated y-axis. This enables selective delivery of coalescing agent across the whole width and length of the support 204 in a single pass.

In FIG. 2c, each of the agent distributors 202c-d may have a shorter length that does not enable it to span the whole width of the support member 204. In this example, each of the agent distributors 202c-d may be laterally movable along the entire width of the support member 204 along the illustrated x-axis. Thus, using the carriage 203b, the agent distributors 202c-d and the imaging system 230b may be movable bi-directionally across the length of the support 204 along the illustrated y-axis. This enables selective delivery of coalescing agent across the whole width and length of the support 204 in multiple passes.

In other examples the agent distributors may be fixed, and the support member 204 may move relative to the agent distributors.

It should be noted that the term ‘width’ used herein is used to generally denote the shortest dimension in the plane parallel to the x and y axes illustrated in FIGS. 2a-c, whilst the term ‘length’ used herein is used to generally denote the longest dimension in this plane. However, it will be understood that in other examples the term ‘width’ may be interchangeable with the term ‘length’.

The system 200 may further comprise a build material distributor 224 to provide, e.g. deliver and/or deposit, successive layers of build material on the support member 204. Suitable build material distributors 224 may include, for example, a wiper blade and a roller. Build material may be supplied to the build material distributor 224 from a hopper or build material store. In the example shown the build material distributor 224 moves across the length (y-axis) of the support member 204 to deposit a layer of build material. As previously described, a layer of build material will be deposited on the support member 204, whereas subsequent layers of build material will be deposited on a previously deposited layer of build material. The build material distributor 224 may be a fixed part of the system 200, or may not be a fixed part of the system 200, instead being, for example, a part of a removable module. In some examples, the build material distributor 224 may be mounted on the carriage 203a or 203b.

In some examples, the thickness of each layer may have a value selected from the range of between about 50 to about 300 microns, or about 90 to about 110 microns, or about 250 microns, although in other examples thinner or thicker layers of build material may be provided. The thickness may be controlled by the controller 210, for example based on the instructions 218.

In some examples, there may be any number of additional agent distributors and build material distributors relative to the distributors shown in FIGS. 2a-c. In some examples, as shown in FIGS. 2b-c, the distributors of system 200 may be located on the same carriage, either adjacent to each other or separated by a short distance. In other examples, two or more carriages each may contain a distributor. For example, each distributor may be located in its own separate carriage. Any additional distributors may have similar features as those discussed earlier with reference to the coalescing agent distributor 202. However, in some examples, different agent distributors may deliver different coalescing agents and/or coalescence modifier agents, for example.

In the example shown the support 204 is moveable in the z-axis such that as new layers of build material are deposited a predetermined gap is maintained between the surface of the most recently deposited layer of build material and lower surface of the agent distributor 202. In other examples, however, the support 204 may not be movable in the z-axis and the agent distributor 202 may be movable in the z-axis.

The system 200 may additionally include an energy source 226 to apply energy to build material to cause the solidification of portions of the build material according to where coalescing agent has been delivered or has penetrated. In some examples, the energy source 226 is an infra-red (IR) radiation source, near infra-red radiation source, halogen radiation source, or a light emitting diode. In some examples, the energy source 226 may be a single energy source that is able to uniformly apply energy to build material deposited on the support 204. In some examples, the energy source 226 may comprise an array of energy sources.

In some examples, the energy source 226 is configured to apply energy in a substantially uniform manner to the whole surface of a layer of build material. In these examples the energy source 226 may be said to be an unfocused energy source. In these examples, a whole layer may have energy applied thereto simultaneously, which may help increase the speed at which a three-dimensional object may be generated.

In other examples, the energy source 226 is configured to apply energy in a substantially uniform manner to a portion of the whole surface of a layer of build material. For example, the energy source 226 may be configured to apply energy to a strip of the whole surface of a layer of build material. In these examples the energy source may be moved or scanned across the layer of build material such that a substantially equal amount of energy is ultimately applied across the whole surface of a layer of build material.

In some examples, the energy source 226 may be mounted on the moveable carriage 203a or 203b.

In other examples, the energy source 226 may apply a variable amount of energy as it is moved across the layer of build material, for example in accordance with agent delivery control data 208 of instructions 218. For example, the controller 210 may control the energy source only to apply energy to portions of build material on which coalescing agent has been applied.

In further examples, the energy source 226 may be a focused energy source, such as a laser beam. In this example the laser beam may be controlled to scan across the whole or a portion of a layer of build material. In these examples the laser beam may be controlled to scan across a layer of build material in accordance with agent delivery control data. For example, the laser beam may be controlled to apply energy to those portions of a layer of on which coalescing agent is delivered.

The combination of the energy supplied, the build material, and the coalescing agent may be selected such that, excluding the effects of any coalescence bleed: i) portions of the build material on which no coalescing agent have been delivered do not coalesce when energy is temporarily applied thereto; ii) portions of the build material on which only coalescing agent has been delivered or has penetrated coalesce when energy is temporarily applied thereto do coalesce.

The system 200 may additionally include a heater 231 to emit heat to maintain build material deposited on the support 204 within a predetermined temperature range. The heater 231 may have any suitable configuration. One example is shown in FIG. 2d, which is a simplified isometric illustration of a heater 231 for an additive manufacturing system according to some examples. The heater 231 may have an array of heating units 232, as shown in FIG. 2d. The heating units 232 may be each be any suitable heating unit, for example a heat lamp such as an infra-red lamp. The heating units 232 may have any suitable shapes or configurations such as rectangular as shown in FIG. 2d. In other examples they may be circular, rod shaped, or bulb shaped, for example. The configuration may be optimized to provide a homogeneous heat distribution toward the area spanned by the build material. Each heating unit 232, or groups of heating units 232, may have an adjustable current or voltage supply to variably control the local energy density applied to the build material surface.

Each heating unit 232 may correspond to its own respective area of the build material, such that each heating unit 232 may emit heat substantially toward its own area rather than areas covered by other heating units 232. For example, each of the sixteen heating units 232 in FIG. 2d may heat one of sixteen different areas of the build material, where the sixteen areas collectively cover the entire area of the build material. However, in some examples, each heating unit 232 may also emit, to a lesser extent, some heat which influences an adjacent area.

Each heating unit 232 may be coupled to a respective sensor 234 which may measure a property of the heating 232. The property may be an electrical property such as current or voltage of the heating unit 232.

In some examples, additionally or alternatively to the heater 231, a heater may be provided below the platen of the support member 204 to conductively heat the support member 204 and thereby the build material. The conductive heater may be to uniformly heat the build material across its area on the support member 204.

The system 200 may additionally include a sensor 228 which may be to detect radiation or acoustic waves, for example. The sensor 228 may be oriented generally centrally and facing generally directly toward the build material, such that the optical axis of the camera targets the center line of the support member 204, to allow a generally symmetric capture of radiation or acoustic waves from the build material. This may minimize perspective distortions of the build material surface, thus minimizing the need for corrections. Additionally, the sensor 228 may, for example, be to (1) capture radiation or acoustic waves over a wide region covering an entire layer of build material, for example by using suitable magnification, (2) capture a series of measurements of the entire layer which are later averaged, or (3) capture a series of measurements each covering a portion of the layer that together cover the entire layer. In some examples, the sensor 228 may be in a fixed location relative to the support member 204, but in other examples may be moveable if other components, when moving, disrupt the line of sight between the camera 228 and the support member 204.

In some examples, an array of sensors 228 may be used. Each sensor 228 may correspond to its own respective area of the build material, such that each sensor 228 may perform measurements on its own area rather than areas corresponding to other sensors 228. The array of sensors 228 may collectively cover the entire area of the build material. In some examples, both radiation and acoustic sensors may be used.

The sensor 228 may, for example, be a point contactless temperature sensor such a thermopile, or such as a thermographic camera. In other examples, the sensor 228 may include an array of fixed-location pyrometers which each capture radiation from a single area of the build material. In other examples, the sensor 228 may be a single pyrometer which may be operable to sweep or scan over the entire area of the build material. Other types of sensors may also be used. The sensor 228 may be to capture a radiation distribution, for example in the IR range, emitted by each point of the build material across the area spanned by the build material on the support member 204. The temperature sensor 228 may output the radiation distribution to the controller 210, which may determine a temperature distribution across the build material based on known relationships, such as a black body distribution, between temperature and radiation intensity for the material used as the build material. For example, the radiation frequencies of the radiation distribution may have their highest intensities at particular values in the infra-red (IR) range. This may be used to determine the temperature distribution comprising a plurality of temperatures across the build material.

In some examples, the sensor 228 may be a ranging sensor, and may comprise, for example, an acoustic sensor, diode emitter, radar, or any other ranging sensor. The ranging sensor may be to determine the time of flight of an acoustic wave or radiation emitted from the sensor 228 and then detected by the sensor 228 after reflection by the build material.

The controller 210 may obtain or generate agent delivery control data 208 which may define for each slice of the three-dimensional object to be generated the portions or the locations on the build material, if any, at which agent is to be delivered.

In some examples, the agent delivery control data 208 may be generated based on object design data representing a three-dimensional model of an object to be generated, and/or from object design data representing properties of the object. The model may define the solid portions of the object, and may be processed by the three-dimensional object processing system to generate slices of parallel planes of the model. Each slice may define a portion of a respective layer of build material that is to be solidified by the additive manufacturing system. The object property data may define properties of the object such as density, surface roughness, strength, and the like.

The object design data and object property data may be received, for example, from a user via an input device 220, as input from a user, from a software driver, from a software application such as a computer aided design (CAD) application, or may be obtained from a memory storing default or user-defined object design data and object property data.

The agent delivery control data 208 may describe, for each layer of build material to be processed, locations or portions on the build material at which coalescing agent is to be delivered. In one example the locations or portions of the build material at which coalescing agent is to be delivered are defined by way of respective patterns.

FIG. 3 is a flow diagram illustrating a method 300 of generating a three-dimensional object according to some examples. In some examples, the orderings shown may be varied, some elements may occur simultaneously, some elements may be added, and some elements may be omitted.

In describing FIG. 3, reference will be made to FIGS. 2, 4, and 5a-d. FIG. 4 illustrates data representing a three-dimensional object modified based on dead zone data. FIG. 4 shows original data 400a representing the three-dimensional object to be generated, and data 400b generated based on modification to the original data 400a. FIGS. 5a-d show a series of cross-sectional side views of layers of build material according to some examples.

At 302, data representing the three dimensional object may be generated or obtained by the controller 210. “Data representing the three dimensional object” is defined herein to include any data defining the object from its initial generation as a three dimensional object model, to its conversion into slice data, and to its conversion into a form suitable for controlling an agent distributor such as agent delivery control data 208. Such data is also defined to include data used an agent distributor to define which nozzles of an agent distributor to use. Thus, it is understood that “data representing the three dimensional” object includes, for example, both (1) data corresponding to locations on a support member such that the object may be shifted to be generated in a different portion of the platform, e.g. if the support member is fixed, or (2) data corresponding to nozzles of an agent to be used even where the location of the object to be generated on the platform is not shifted, but rather the support member is shifted, e.g. if the support member is movable, such that the “shifting” of the object herein may correspond to different nozzles being used.

At 304, a layer 502b of build material may be provided, as shown in FIG. 5a. For example, the controller 210 may control the build material distributor 224 to provide the layer 502b on a previously completed layer 502a on the support member 204 by causing the build material distributor 224 to move along the y-axis as discussed earlier. The completed layer 502a may include a solidified portion 506. Although a completed layer 502a is shown in FIGS. 5a-d for illustrative purposes, it is understood that 304 to 314 may initially be applied to generate the first layer 502a.

At 306, the sensors 228, 230 or 234, may detect properties of the system 200 or build material which may be indicative of whether a print dead zone exists. The print dead zone may be caused by a defect of the layer of build material or a malfunction of a heater 228, carriage 203a or 203b, or build material distributor 224, for example.

Data from the sensor 230, e.g. a scan bar, and/or radiation sensors 228 may be used to determine a property such as temperature or a configuration or shape of build material. Data from ranging sensors 228 may be used to determine a property such as configuration or shape of build material. Data from sensors 234 coupled to the heating units 232 may be used to determine a property such as voltage and current of the heating units 232. In some examples, sensors (e.g. imaging devices or other sensors) on the carriage or build material distributor may be used to determine properties such as alignment of or damage to the carriage 230a or 230b or build material distributor 224. These determinations may be made by the controller 210 or by processors in the sensors.

At 308, whether the determined property is indicative of a print dead zone is determined. This determination may be made, for example, manually by a user based on user input to the input device 220, automatically by the controller 210, or a combination thereof.

If the determination made manually by the user, properties such as temperature or configuration of the build material, or voltage or current of the heater, may by visually and/or textually displayed by the output device 222 as a dynamic dashboard using any suitable visualization method. For example, a visual representation of the layer of the build material, object, and/or heating units 234 may be displayed with an overlaid depiction of the properties of the build material and heater. Based on the visual and/or textual display, the user may identify a print dead zone by providing input to the input device 220 that a heating unit, carriage, or build material distributor is malfunctioning and/or an area of build material is at an incorrect temperature or is experiencing a defect such as abnormal accumulation, deformations, holes, obstacles in the print bed, broken or incorrectly positioned parts, or any other defects that may render a particular area of the build material at risk for producing defective parts. For example, such defects may be due to malfunctioning of the heater 231 (e.g. due to improper heating), carriage 230a or 230a (e.g. due to misalignment and/or improper delivery of agents, therefore causing defects in the build material), or build material distributor 224 (e.g. due to misalignment and/or damage causing build material not to be spread properly).

If the determination is made automatically by the controller 210, properties such as temperature or configuration of the build material, or voltage or current of the heater, may be analyzed by the controller 210 to determine whether the heating unit is malfunctioning and/or an area of build material is at an incorrect temperature or is experiencing a defect. In some examples, data from the different sensors 228, 230, and 234 may be analyzed. In some examples, data from one sensor may indicate a print dead zone, whereas in other examples data from multiple sensors may be combined and weighted (based on sensor precision or importance of the physical process to whether a print dead zone is present) to identify a print dead zone. In some examples, the determination may be made by comparing the sensor data to reference data defining expected values of the property for a given type of print job. The reference data may have been obtained during calibration or during previous print jobs, or may have been defined by a user, e.g. by input into the input device 220. In some examples, the determinations may be made by comparing the sensor data of a given area of the build material to other areas of the build material. In some examples, the controller 210 may apply various determination techniques such as multi-objective constrained optimization algorithms, e.g., genetic algorithms, ant colony optimization, and/or particle swarm optimization. In some examples, the controller 210 may apply machine learning techniques to refine print dead zone identification based on additional experience with print jobs.

If the determination is made based on a combination of manual user input and determination by a controller 210, the controller 210 may identify candidate print dead zones, present the candidate print dead zones to the user using e.g. a visual and/or textual display on the output device 222, and the user may provide input to the input device 220 to select that a candidate print dead zone is a print dead zone.

If at 308 the property is determined to be indicative of a print dead zone then the method may proceed to 310. If at 308 the property is determined not to be indicative of a print dead zone then the method may proceed to 311.

At 310, corrective action may be taken based on the identification of a print dead zone.

In some examples, the corrective action may comprise instructing, by the controller 210, a malfunctioning heater 231 or heating unit 234 corresponding to an area of the build material having the print dead zone to be prevented from malfunctioning, e.g. by recalibrating loop controls to provide the correct amount of heat to the build material.

In some examples, the corrective action may comprise instructing, by the controller 210, a malfunctioning carriage 230a or 230b corresponding to an area of the build material having the print dead zone to be prevented from malfunctioning, e.g. by re-aligning the movement of the carriage 230a or 230b to the print bed in the X, Y, and/or Z-axis direction.

In some examples, the corrective action may comprise instructing, by the controller 210, a malfunctioning build material distributor 224 corresponding to an area of the build material having the print dead zone to be prevented from malfunctioning, e.g. by re-aligning the movement of the build material distributor 224 to the print bed in the X, Y, and/or Z-axis direction.

In some examples, the corrective action may comprise modifying, by the controller 210, data 400a representing the three-dimensional object 402 based on an identified dead zone 404 to shift the coordinates of an object 402 and/or to cancel the object 402. The object may be shifted to a region in which there are no dead zones. In the example of FIG. 4, the data 400b is generated based on modifications to the original data 400a. The object 402 is shifted out of the region 406 corresponding to the malfunctioning nozzles 404. If part of the object has already been generated in the current layer, then the object may be cancelled and re-started in a different area of the build material to avoid the print dead zone.

In some examples, the data may include a plurality of slice data, wherein each slice data, for example agent delivery control data, represents a build area in which a two-dimensional slice of an object is located. Thus, each slice may be moved to a different location in its respective area of the slice data, such that the coordinates of the object as a whole may be shifted. Each slice may be moved the same amount to ensure that the whole object is moved.

In other examples, the data may include three-dimensional object data, such as the object design data, wherein the data represents a build volume in which the three-dimensional object is to be located. Thus, the object may be moved to a different location in the volume of the data, such that the coordinates of the object as a whole may be shifted.

Although 306 to 310 are shown as occurring after providing each layer of build material in 304, 306 to 310 may instead occur before providing the first layer such that the data modification may occur before beginning the print job.

At 311, the layer 502b of build material may be heated by the heater 231 to heat and/or maintain the build material within a predetermined temperature range. The predetermined temperature range may, for example, be below the temperature at which the build material would experience bonding in the presence of coalescing agent 504. For example, the predetermined temperature range may be between about 155 and about 160 degrees Celsius, or the range may be centered at about 160 degrees Celsius. Pre-heating may help reduce the amount of energy that has to be applied by the energy source 226 to cause coalescence and subsequent solidification of build material on which coalescing agent has been delivered or has penetrated.

At 312, as shown in FIG. 5b, coalescing agent 504 may be selectively delivered to the surface of portions of the layer 502b. As discussed earlier, the agent 504 may be delivered by agent distributor 502, for example in the form of fluids such as liquid droplets.

The selective delivery of the agent 504 may be performed in patterns on the portions of the layer 502b that the data representing the three-dimensional object may define to become solid to form part of the three-dimensional object being generated. The data representing the three-dimensional object may be unmodified data if a dead zone was not identified and modified data if a dead zone was identified. “Selective delivery” means that agent may be delivered to selected portions of the surface layer of the build material in various patterns.

In some examples, coalescence modifier agent may similarly be selectively delivered to portions of the layer 602b.

FIG. 5c shows coalescing agent 504 having penetrated substantially completely into the portions of the layer 502b of build material, but in other examples, the degree of penetration may be less than 100%. The degree of penetration may depend, for example, on the quantity of agent delivered, on the nature of the build material, on the nature of the agent, etc.

At 314, a predetermined level of energy may be temporarily applied to the layer 502b of build material. In various examples, the energy applied may be infra-red or near infra-red energy, microwave energy, ultra-violet (UV) light, halogen light, ultra-sonic energy, or the like. The temporary application of energy may cause the portions of the build material on which coalescing agent 504 was delivered to heat up above the melting point of the build material and to coalesce. In some examples, the energy source may be focused. In other examples, the energy source may be unfocused, and the temporary application of energy may cause the portions of the build material on which coalescing agent 504 has been delivered or has penetrated to heat up above the melting point of the build material and to coalesce. For example, the temperature of some or all of the layer 502b may achieve about 220 degrees Celsius. Upon cooling, the portions having coalescing agent 504 may coalesce may become solid and form part of the three-dimensional object being generated, as shown in FIG. 5d.

As discussed earlier, one such solidified portion 506 may have been generated in a previous iteration. The heat absorbed during the application of energy may propagate to the previously solidified portion 506 to cause part of portion 506 to heat up above its melting point. This effect helps creates a portion 508 that has strong interlayer bonding between adjacent layers of solidified build material, as shown in FIG. 5d.

After a layer of build material has been processed as described above in 304 to 314, new layers of build material may be provided on top of the previously processed layer of build material. In this way, the previously processed layer of build material acts as a support for a subsequent layer of build material. The process of 304 to 314 may then be repeated to generate a three-dimensional object layer by layer.

All of the features disclosed in this specification (including any accompanying claims, abstract and drawings), and/or all of the elements of any method or process so disclosed, may be combined in any combination, except combinations where at least some of such features and/or elements are mutually exclusive.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

1. A system comprising:
a sensor to detect a property indicative of a print dead zone caused by a defect of build material to be used for generating the three-dimensional object or a malfunction of a heater that is to heat the build material, a build material distributor that is to provide the build material, or a carriage;
a processor to receive, from the sensor, dead zone data relating to the print dead zone, and to prevent the malfunction of the heater, the build material distributor, or the carriage, or to modify data representing the three-dimensional object to cause the three-dimensional object to be shifted such that three-dimensional object is to be printed outside the print dead zone.

2. The system of claim 1 wherein the processor is to modify the data representing the three-dimensional object to cause the three-dimensional object to be shifted such that three-dimensional object is to be printed outside the print dead zone.

3. The system of claim 1 wherein the processor is to prevent the malfunction of the heater.

4. The system of claim 1 further comprising the heater, wherein the print dead zone is caused by the malfunction of the heater.

5. The system of claim 4 wherein the property is a temperature of the build material.

6. The system of claim 5 wherein the sensor is a scan bar attached to a carriage or a thermographic camera disposed above the build material.

7. The system of claim 5 wherein the heater comprises an array of heating units, each heating unit to heat a respective region of a plurality of regions of the build material, wherein the temperature is of the region of the plurality of regions having the print dead zone.

8. The system of claim 4 wherein the property is a voltage or current of the heater.

9. The system of claim 8 wherein heater comprises an array of heating units, wherein the voltage or the current is of a heating unit of the array of heating units.

10. The system of claim 1 wherein the print dead zone is caused by the defect of the building material, wherein the property is of the build material.

11. The system of claim 10 wherein the sensor is a scan bar attached to a carriage, a thermographic camera disposed above the build material, or an acoustic sensor.

12. The system of claim 1 wherein property being indicative of the print dead zone is determined automatically by the processor.

13. The system of claim 1 wherein property being indicative of the print dead zone is determined manually based on user input.

14. A method comprising:
measuring, by a sensor, a property of build material to be used for generating a three-dimensional object, of a heater to be used to heat the build material, of a build material distributor to be used to provide the build material, or a carriage;
based on the measured property, identifying a print dead zone caused by a defect of the build material or a malfunction of the heater, the build material distributor that is to provide the build material, or the carriage;
based on the identification, preventing the malfunction of the heater, the build material distributor, or the carriage, or transforming data representing the three-dimensional object to cause the three-dimensional object to be shifted such that three-dimensional object is to be printed in an area of the build material outside the print dead zone; and
generating the three dimensional object using the correctly functioning heater, build material distributor, or carriage, or in accordance with the modified data.

15. A non-transitory computer readable storage medium including executable instructions that, when executed by a processor, cause the processor to:
receive, from sensors, data representing measured properties of build material to be used for generating the three-dimensional object or of a heater to be used to heat the build material;
receive or determine an identification of a print dead zone resulting from a defect of the build material or a malfunction of a heater, the identification based on the measured properties; and
prevent the malfunction of the heater or modify data representing the three-dimensional object to shift the printing location of the three-dimensional object outside the print dead zone.
